(19) United States
(12) Patent Application Publication
(10) Pub. No.: US 2008/0280503 A1
(43) Pub. Date: Nov. 13, 2008

(54) Electrical Connections for Plastic Panels Having Conductive Grids

(76) Inventors: Eric F.J.M. van der Meulen, Wixom, MI (US); Robert A. Schwenke, Austin, TX (US); Keith D. Weiss, Fenton, MI (US)

Correspondence Address: EXATEC;C/O BRINKS HOFER GILSON & LIONE, 524 South Main Street, Suite 200, Ann Arbor, MI, 48104, US

(21) Appl. No.: 12/116,841

(22) Filed: May 7, 2008

Related U.S. Application Data
(60) Provisional application No. 60/916,309, filed on May 7, 2007.

(51) Int. Cl. H01R 13/405

(52) U.S. Cl. 439/736

(57) ABSTRACT

A plastic panel system including a transparent plastic panel and an electrically conductive grid. The panel includes a substrate and the grid is provided on the panel so as to overlie the substrate. Including with the grid is at least one conductive mounting location. An electrical connector, which includes a plastic portion and an electrically conductive portion, is secured to the panel by ultrasonically welding the plastic portion to the panel. As a result of the retention of the connector with the panel, the conductive portion of the panel is in electrical contact with the mounting location of the conductive grid. The electrical system of an automotive vehicle can be attached to the connector of the panel system.

### CROSS REFERENCE TO RELATED APPLICATION

This invention claim the benefit of U.S. provisional application No. 60/916,309, filed May 7, 2007, the entire contents of which are herein incorporated by reference.

### BACKGROUND OF THE INVENTION

1. Field of the Invention

The present invention generally relates to the connection of electrical terminals to plastic panels having electrically conductive grids thereon. More specifically, the present invention relates to the connection of electrical terminals to an electrical circuit applied to a plastic substrate in a plastic window system in order to provide such things as defrosting and defogging, signal reception, lighting and other functionalities to the window system.

2. Description of the Related Technology

Electrically conductive grids have long been used to provide functional capabilities to glass panels. For example, electrically heatable grids have been used for the defrosting and defogging of windows, particularly backlights of automobiles. Various types of electrically heated windows have been devised and these typically include an electrically conductive heating grid located toward either the interior or exterior side of the window. The heating grid typically includes a pair of opposed busbars, between which a series of grid lines extend. During the passing of electric current through the heating grid, the resistance of the grid lines results in the generation of heat. This heat dissipates across the window, subsequently defrosting or defogging the window. In order to provide electricity to the heating grid, the heating grid is coupled to the electrical system of the automotive vehicle.

To couple the automotive vehicle's electrical system to the heating grid, the busbars of heating grids have been provided with connector tabs that extend beyond the edges of the window. Wire harness terminals, from the vehicle's electrical system, engage the tabs. The terminals can be of a variety of constructions, but often include a spring metal contact, encased within a housing. When the housing is attached to a tab, the contact is biased against and into contact with the busbar. In an alternate construction, bonding pads are integrally formed with the busbars and the terminals from the vehicle's electrical system are directly soldered onto the bonding pads.

The above constructions have known problems and limitations. For example, over the life of the vehicle, spring contacts may become loose due to fatigue and/or vibration, resulting in a non-working or a poorly working heating grid. With regard to pad bonding constructions, the application of too much or too little solder weakens the joint between the terminals and the bonding pad, which may result in the terminal being easily dislodged from the bonding pad itself. Due to the low glass transition temperature of the plastics used in plastic panels and windows, traditional high temperature solder cannot be used to make robust connections to the busbars. Unfortunately, the commercially available low temperature solders, and even, electrically conductive adhesives, can have unacceptable bonding strengths and/or reliability.

In view of the above, it is apparent that improved connection constructions for attaching terminals to the busbars of heating grids, or other electrofunctional materials on plastic panels are required.

### SUMMARY

In satisfying the above need and overcoming the drawbacks and limitations of the known technology, the present invention resolves the connection problem by providing a plastic window or body panel system including a transparent plastic panel and an electrically conductive grid provided on the plastic panel. The conductive grid includes at least one conductive mounting location and an electrical terminal is electrically connected to this mounting location.

In another aspect of the present invention, the conductive grid is one of an antenna, an electroluminescent border, a heating grid and chromogenic devices, such as electrochromic devices, photochromic devices, liquid crystal devices, user-controllable-photochromic devices, polymer-dispersed-liquid-crystal devices, and suspended particle devices commonly known in the art.

In one aspect, the present invention is a transparent plastic automotive panel system comprising a transparent plastic panel including a substrate and an electrically conductive grid overlaying the substrate. The grid includes at least one conductive mounting location. An electrical connector is secured to the panel and includes a plastic portion and an electrically conductive portion. The plastic portion is ultrasonically welded to the panel and the conductive portion is, as a result, electrically connected with the conductive mounting location.

In another aspect of the invention, a terminal of an electrical system is electrically connected to the connector.

In another aspect of the invention, the conductive grid is one of an antenna, an electroluminescent border, an electrical switch, a heating grid and a chromogenic device.

In another aspect of the invention, the conductive grid is applied directly to the panel and the plastic portion of the connector extends through the conductive grid.

In another aspect of the invention, the conductive grid is applied directly to the panel and the plastic portion of the connector extends at least partially around the conductive grid.

In another aspect of the invention, the panel includes a protective coating over a substrate, the conductive grid being applied over the protective coating and the plastic portion of the connector extending through the conductive grid and the protective coating.

In another aspect of the invention, the conductive grid is applied over a protective coating on a substrate of the panel and the plastic portion of the connector extends at least partially around the conductive grid.

In another aspect of the invention, the conductive portion of the connector is insert molded within the plastic portion of the connector.

In another aspect of the invention, the conductive portion includes a threaded bore.

In another aspect of the invention, the connector includes a mounting pad having knurls formed thereon, the knurls being in contact with the panel.

In another aspect of the invention, the connector includes a plastic cap, the cap being ultrasonically welded to the panel and retaining the conductive portion of the connector in contact with the conductive mounting location.

In another aspect of the invention, the conductive portion of the connector is insert molded with the plastic cap.

In another aspect of the invention, the conductive portion is a solder button located between the cap and the conductive mounting location.

In another aspect of the invention, the cap includes a channel extending longitudinally along the cap, the conductive portion of the connector including a wire received within the channel.

In another aspect of the invention, a plurality of transverse ribs is provided within the channel, the ribs engaging the wire.

In another aspect of the invention, the cap includes a plurality of feet, the feet being ultrasonically welded to the panel.

In another aspect of the invention, the feet are intermittently spaced on the cap.

In another aspect of the invention, the feet extend longitudinally along the cap.

In another aspect of the invention, the feet are circumferentially located on the cap.

In another aspect of the invention, the conductive mounting location has voids formed in locations corresponding with the feet locations on the cap.

In another aspect of the invention, the conductive portion includes a post extending through a central opening in the cap.

In another aspect of the invention, the post is connected to a base portion in contact with the conductive mounting location, the base portion being of a size larger than the central opening and being compressed between the cap and the conductive mounting location.

In another aspect of the invention, the cap is engaged within a recess formed in the panel.

In another aspect of the invention, the cap defines a shear joint with portions defining the recess in the panel.

In another aspect of the invention, the cap includes a plurality of feet, the feet including side surfaces that are angled relative to side walls of portions defining the recess, the side surfaces of the feet being ultrasonically welded to the side walls of the panel and defining a shear joint therewith.

In another aspect of the invention, the conductive grid is a heater grid integrally formed with the plastic panel, the heater grid having opposing busbars between which extend a plurality of grid lines, whereby the plurality of grid lines heat via resistive heating when an electrical current from a power supply travels through each of the plurality of grid lines.

### BRIEF DESCRIPTION OF THE DRAWINGS

FIG. 1 is a schematic view of a window assembly embodying the principles of the present invention;

FIG. 2 is a schematic partial cross sectional view of one embodiment of the invention;

FIG. 3 is a schematic partial cross sectional view of another embodiment of the invention;

FIG. 4 is a schematic partial cross sectional view of further embodiment of the invention;

FIG. 5 is a schematic partial cross sectional view of an additional embodiment of the invention;

FIG. 6 is a schematic partial cross sectional view of one embodiment of the invention;

FIG. 7 is a schematic partial cross sectional view of another embodiment of the invention;

FIG. 8A is a cross sectional view of the cap utilized in the embodiment of FIG. 7;

FIG. 8B is side view of the cap seen in FIG. 8a;

FIG. 8C is a bottom view of the cap seen in FIG. 8a;

FIG. 9A is a schematic partial cross sectional view of an additional embodiment of the invention;

FIG. 9B is a bottom view of the connector seen in FIG. 9a;

FIG. 10A is a schematic sectional view of a further embodiment of the invention at initial engagement with a plastic panel; and

FIG. 10B is a schematic sectional view of the embodiment seen in

FIG. 10a fully engaged with the plastic panel.

### DETAILED DESCRIPTION

The following description of the preferred embodiments is merely exemplary in nature and it not intended to limit the scope of the invention or its application or uses.

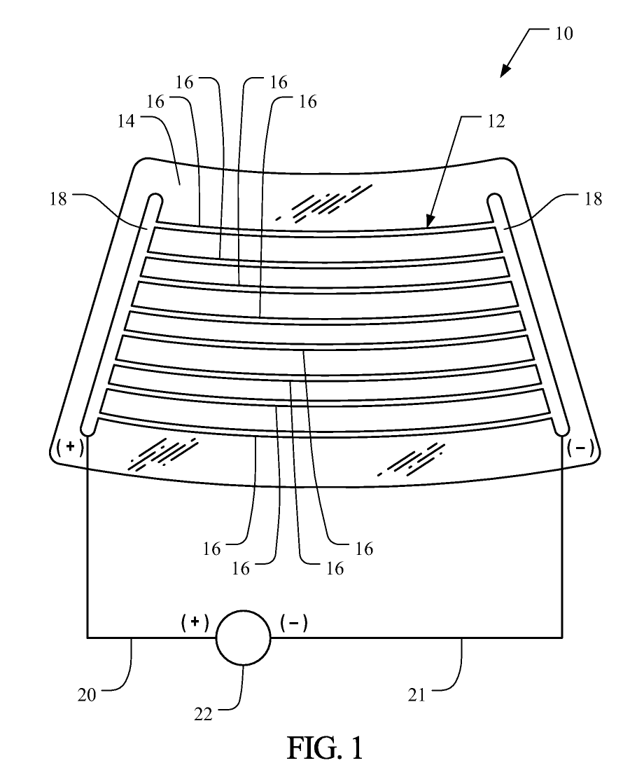

Referring now to FIG. 1, a plastic window or body panel system 10 is generally illustrated therein and includes, as its primary components, an electrically conductive grid 12 provided on a panel 14. While the conductive grid 12 may be one of a variety of elements providing functionality to the window system 10. As such, the conductive grid may be one of an antenna, an electroluminescent border, a heating grid and a chromogenic device, such as electrochromic devices, photochromic devices, liquid crystal devices, user-controllable-photochromic devices, polymer-dispersed-liquid-crystal devices, and suspended particle devices as are commonly known in the art. For convenience, however, the conductive grid 12 will be herein generally described as a heating grid 12.

The heating grid 12 preferably includes a series of grid lines 16 extending between generally opposed busbars 18, although other constructions of heating grids may be employed. Furthermore, at least some of the grid lines 16 may be replaced by a conductive film or coating extending between the remaining grid lines 16.

The busbars 18 are designated as positive and negative busbars and are respectively connected to positive and negative leads 20, 21 of a power supply 22. The power supply 22 may be the electrical system of an automotive vehicle. Upon the application of a voltage to the heating grid 12, electric current will flow through the grid lines 16 from the positive busbar 18 to the negative busbar 19 and, as a result, the grid lines 16 will heat up via resistive heating. The widths and lengths of the bus bars 18 and grid lines 16 may be of any suitable dimension and will, in part, be determined by the size and other characteristics of the window system 10. Additionally, the busbars 18 may be applied over the grid lines 16, beneath the grid lines 16, or on the same layer as the grid lines 16.

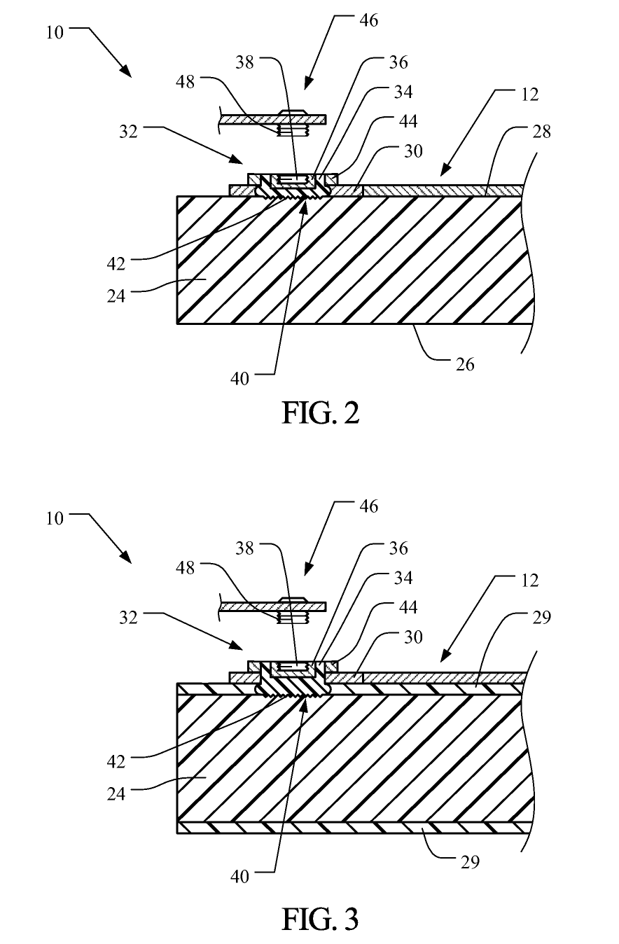

Panel 14 more specifically includes, as seen in FIG. 2, a transparent plastic base layer or substrate 24 having opposing first and second surfaces, respectively designated at 26 and 28. The surfaces 26, 28 are respectively oriented with respect to the exterior and interior surfaces of a window system 10 incorporated into an automotive vehicle. The panel 14 may optionally include a transparent, plastic film with the heating grid 12 being provided on a surface of the film such that in the final construction of the panel 14, substrate 24 and the film are integrally melt bonded together to encapsulate the heating grid 12 between the substrate 24 and the film. The panel 14 may also further include a weathering layer and/or an abrasion resistant layer, applied to one or both sides thereof. Herein, the weathering layers and the abrasion resistant layer, individually and collectively, may be referred to as a protective coating 29.

The substrate 24 is formed of a plastic resin, which may be, but is not limited to, polycarbonate, acrylic, polyarylate, polyester and polysulfone resins, as well as copolymers and mixtures thereof, as well as being copolymerized or blended with other polymers such as PBT, ABS, or polyethylene. The substrate may further include various additives, such as colorants, mold release agents, antioxidants, and ultraviolet absorbers (UVAs), among others. The thickness of the substrate 24 is preferably about 2 mm to about 6 mm with about 4 mm to about 5 mm being more preferred.

The substrate 24 may be formed through the use of any technique known to those skilled in the art, such as molding, which includes injection molding, blow molding, and compression molding and/or thermoforming, the latter including thermal forming, vacuum forming, drape forming, and cold forming. Although not necessary, the aforementioned techniques may be used in combination with each other, such as thermoforming a first layer into the shape of a surface of the mold prior to injection molding of another layer onto and integrally bonding with the first layer, thereby, forming a multilayered substrate 24 of the desired shape.

In applying the heating grid 12 to the panel 14, the heating grid 12 may be applied by commonly known printing methods, such as screen printing, although other methods of printing known to those skilled in the art may be used. Such other methods include, but are not limited to mask/spray, inkjet, pad, membrane image transfer or robotic dispensing. Materials suitable for use as conductive inks are well known in the art and therefore not further described herein.

The weathering layer 36 is applied to the substrate 24 beneath or over the heating grid 12 and may be applied to both the first and second surfaces 26, 28 of the substrate 24. Similarly, the abrasion resistant layer 38 may be applied over the weather layer 36 on the exterior side of the substrate 24 and may also be applied over the interior side as well.

While various other coating systems can be used, the weathering layer 36 preferably comprises either a polyurethane coating or a combination of an acrylic primer and a silicone hard-coat. One example of such an acrylic primer is Exatec® SHP 9X, (Exatec, LLC, Wixom, Mich.). In one preferred embodiment, the primer in the weathering layer is a waterborne acrylic primer comprising water as a first co-solvent and an organic liquid as a second co-solvent (such as glycol, ethers, ketones, alcohols, and acetates). The primer may contain additives, such as but not limited to, surfactants, antioxidants, biocides, ultraviolet absorbers (UVAs), and drying agents, among others.

Typically, the primer is coated on the transparent plastic panel 14, air dried, and then thermally cured the silicone hard coat is then applied over the primer layer and is air dried before being cured. By way of example, the resin in the silicone hard-coat is preferably a methylsilsesquioxane resin dispersed in a mixture of alcohol solvents. The silicone hard-coat may also comprise other additives, such as but not limited to surfactants, antioxidants, biocides, ultraviolet absorbers, and drying agents, among others. A preferred silicone hard-coat is Exatec® SHX (Exatec, LLC, Wixom, Mich.).

The weathering layer 36 may be applied to the transparent plastic panel by dipping the panel in the coating at room temperature and atmospheric pressure through a process known to those skilled in the art as dip coating. Alternatively, the weathering layer 36 may be applied by flow coating, curtain coating, spray coating, or other processes known to those skilled in the art.

The abrasion resistant layer 38 is substantially inorganic coating that adds additional or enhanced functionality to the automotive window system 10 by improving abrasion resistance. The abrasion resistance layer 38 preferably is applied on top of the weathering layer 36 and to both sides of the substrate 24. Accordingly, the abrasion resistant layer 38 may be deposited directly onto the substrate 24. Specific examples of possible inorganic coatings comprising the abrasion resistant layer include, but are not limited to, aluminium oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, hydrogenated silicon oxy-carbide, tantalum oxide, titanium oxide, tin oxide, indium tin oxide, yttrium oxide, zinc oxide, zinc selenide, zinc sulfide, zirconium oxide, zirconium titanate, or glass, and mixtures or blends thereof.

The abrasion resistant layer 36 may be applied by any technique known to those skilled in the art. These techniques include deposition from reactive species, such as those employed in vacuum-assisted deposition processes, and atmospheric coating processes, such as those used to apply sol-gel coatings to substrates. Examples of vacuum-assisted deposition processes include, but not limited to, plasma enhanced chemical vapor deposition (PECVD), arc-PECVD, ion assisted plasma deposition, magnetron sputtering, electron beam evaporation, and ion beam sputtering. Examples of atmospheric coating processes include, but are not limited to, curtain coating, spray coating, spin coating, dip coating, and flow coating.

Several constructions for connecting an electrical connector to the conductive grid 12 are proposed herein. The present invention is differentiated from prior art in that the electrical connectors are ultrasonically welded directly to the substrate 24 so as to make electrical contact with the conductive grid 12.

Ultrasonic welding involves the use of high frequency sound energy to soften or melt the thermoplastic at the joint or interface between two parts. The parts to be joined are generally held together under pressure and are then subjected to ultrasonic vibrations, usually at a frequency of 20, 30, 35 or 40 kHz. The ability to weld a component successfully is governed by the design of the equipment, the mechanical properties of the material to be welded and the design of the components. Since ultrasonic welding is very fast (weld times are typically less than 1 second) and easily automated, it is a widely used technique. In order to guarantee the successful welding of any parts, careful design of components and fixtures is required and, for this reason, the technique is best suited for automatic series production.

An ultrasonic welding machine consists of four main components: a power supply, a converter, an amplitude modifying device (commonly called a “booster”) and an acoustic tool known as the horn (or “sonotrode”). The power supply changes electricity at a frequency of 50-60 Hz into a high frequency electrical supply operating at 20, 30, 35 or 40 kHz. This electrical energy is supplied to the converter. The converter changes the electrical energy into mechanical vibratory energy at ultrasonic frequencies. The vibratory energy is then transmitted through the booster, which increases the amplitude of the sound wave, and the sound waves are then transmitted to the horn. The horn is an acoustic tool that directs and transfers the vibratory energy to the parts being assembled. The horn may also apply pressure to the parts to be welded. From the horn, the vibrations are transmitted through the workpiece to the joint area. In the joint area, the vibratory energy is converted to heat through friction. This heat then softens or melts the thermoplastic at the interface and joins the parts together. Benefits of the process include: very short cycle time, immediate weld strength, energy efficiency, high productivity with low costs and ease of automated assembly line production. The main limitation of the process is the maximum component length that can be welded by a single horn. This limitation is due to the power output capability of a single transducer, the limitations of the horns in transmitting high power, and amplitude control difficulties due to the fact the that length of or to the joints may be comparable to the wavelength of the ultrasound.

In a first embodiment of the invention, the conductor grid 12 is applied directly to one surface of the substrate 24. The conductive grid 12 includes a conductive mounting location 30. As used herein, the conductive mounting location 30 is a generic reference to any mounting location for an electrical terminal on the conductive grid 12. In the example of a plastic window system 10 including a heating grid 12, the conductive mounting location 30 corresponds to a portion of the busbars 18. Thus, the conductive mounting location 30 need not be a discreet portion of the conductive grid 12, but may be a portion thereof, such as a portion of a busbar 18, for example.

In all embodiments of the present invention, the construction includes an electrical connector. The electrical connector generally may extend through, but is also in contact with the conductive mounting location 30. To facilitate receiving of the electrical connector, the conductive mounting location may be formed with voids or open regions (lacking the conductive material of the conductive grid 12) into or over which the electrical connector is located. During ultrasonic welding, the energy of the method is sufficiently high to cause any portion of the conductive grid located beneath the electrical connector to generally melt and allow the electrical connector to be moved under pressure into contact with the substrate 24.

The electrical connector may have a variety of construction and, in this embodiment, the electrical connector 32 includes a plastic outer member 34 within which is located an electrically conductive connector insert 36. The connector insert 36 is preferably formed of a metal, such as copper/brass or steel, and includes an internally threaded bore 38. A base or bottom portion of the outer member 34 defines a mounting pad or surface 40, which is preferably provided with knurls 44 to enhance contact and engagement with the substrate 24 during the ultrasonic welding process.

During ultrasonic welding, the mounting pad 40 and knurls 42 developed significant amounts of heat softening the material at the interfaces with the electrical connector 32, including the conductive mounting location 30 and the substrate 24. Any parts of the conductive grid 12 located between the electrical connector 32 and the substrate is similar melted or softened so as to allow that material to move from beneath to the side of the electrical connector 32. In the softened areas around the electrical connector 30, once the ultrasonic energy is released, the softened areas re-solidify, resulting in the two parts being welded together.

Provided about the upper end of the electrical connector 32 is a contact member 44, which is formed of an electrically conductive material and which is in contact with the conductive mounting location 30. And as such, the contact member 44 may be a metal washer or similar feature.

A threaded terminal 46 of the electrical system to which the system 10 is to be connected includes a threaded screw portion 48. The screw portion 48 is of a size so as to engage the threaded bore 38 of the electrical connector 32. Upon the screw portion 48 being fully engaged in the bore 38, portions 50 of the terminal 46 are brought into contact with the contact member 44, and therefore into electrical contact and communication with the conductive mounting location 30 and the conductive grid 12.

An alternate construction of the present invention is illustrated in FIG. 3. This construction is similar to the previously described construction of FIG. 2, except that the conductive grid 12 is not applied directly to the surface of the substrate 24. Rather, the conductive grid 12 is applied over a protective coating 29. In this construction, the electrical connector 32 extends not only through the conductive mounting location 30, but also through the protective coating 29, which would be generally vacated from beneath the electrical connector 32 during ultrasonic welding.

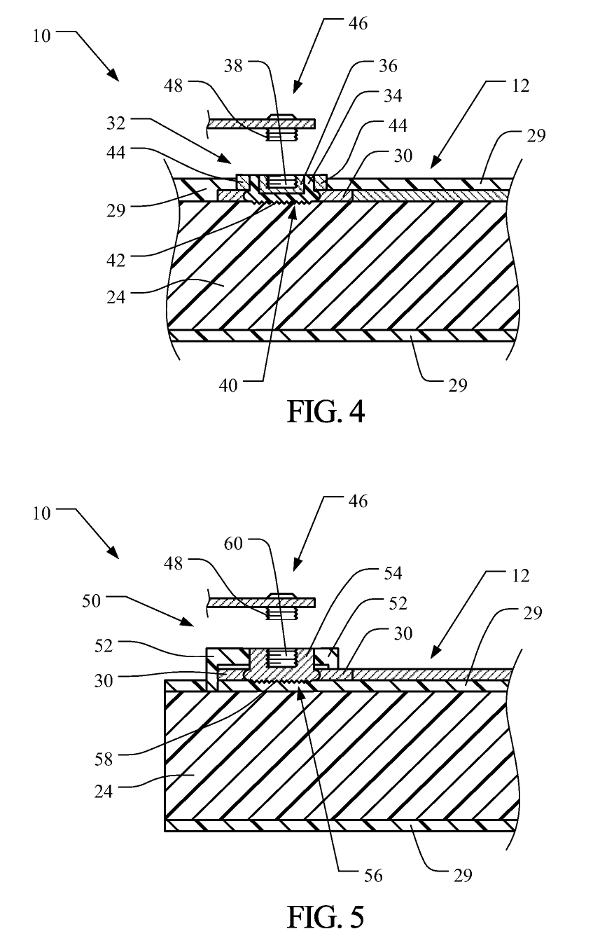

Referring now to FIG. 4, a further embodiment of the present invention is illustrated therein. This embodiment is generally similar to that seen in FIGS. 2 and 3. Unlike those embodiments, the protective coating 29 is applied over the conductive grid 12, which is in turn applied directly to the surface of the substrate 24. As in the prior embodiments, the electrical connector 32 is ultrasonically welded to the substrate 24 at a knurled 42 interface. Like the prior embodiments, a connector insert 36 is molded within an outer member 34 (the later of which defines the knurls 42 of the mounting pad 40), and a contact member 44 provides the electrical pathway from a terminal 46 of an electrical system to the conductive mounting location 30 of the conductive grid 12, when the screw portion 38 of the terminal 46 is engaged within the threaded bore 38 of the connector insert 36.

A further embodiment of the present invention is generally illustrated in FIG. 5. In this embodiment, the protective coating 29 is applied to the surfaces of the substrate 24 and a conductive grid 12 is applied over the protective coating 29. An electrical connector 50 includes an outer member 52 and a connector insert 54. However, unlike the prior embodiments, the outer member 52 of this embodiment is in the form of a cap that extends over and about portions of the conductive mounting location 30 so as to engage the protective coating 29, and subsequently the substrate 24. The connector insert 54 is retained via insert molding within the cap 52 and includes a contact portion 56 having knurls 58 for enhancing contact and engagement with the substrate 24. In this embodiment, the connector insert 54 directly contacts the conductive mounting location 30. During ultrasonic welding, the cap 52 becomes welded to the substrate 24. While not essential, if provided with knurls 58 on the mounting portion 56, the knurls 58 will embed within the material of the conductive mounting location 30 providing an enhanced engagement therewith because of the additional surface area in contact with one another, thus establishing an electrical conductive path from a terminal 46 of an electrical system to the conductive grid 12. Engagement between the terminal 46 and the connector insert 54 is similar to that of the prior embodiments in that the connector insert 54 is provided with an internally threaded bore 60 and a screw portion 48 of the terminal 46 is matingly engaged therein.

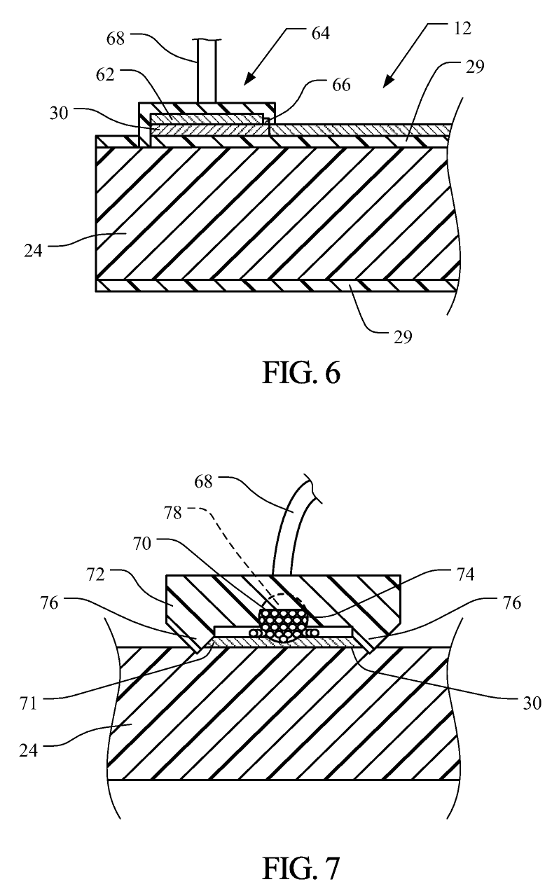

An alternative embodiment illustrated in FIG. 6 wherein the connector insert 54 of FIG. 5 is replaced with a solder button 62. The electrical connector 64 of this embodiment therefore includes the solder button 62 and an outer member/cap 66. The cap 66 is ultrasonically welded to the substrate 24 and encloses the solder button 62 therewithin. During ultrasonic welding, heat generated by the process activates the solder of the solder button 62, thereby securing the solder button 62 to the conductive mounting location 30. An electrical lead 68, is attached to the solder button 62.

Referring now to FIG. 7, shown therein is a further embodiment of the invention in which a braided/twisted wire 70 makes a connection to the conductive mounting location 30, which is illustrated as being directly mounted to the substrate 24. As illustrated in FIG. 7, the twisted wire 70 is the end of a lead 68 coupled to the electrical system with which the plastic panel 10 is employed. A cap 72 is provided over the twisted wire 70 and utilized in helping to secure the twisted wire to the conductive mounting location 30. To receive the twisted wire 70, cap 72 includes a channel 74 extending lengthwise thereacross. The channel 74 is sized such that a portion of the twisted wire 70 protrudes from the channel 74 when the wire 70 is received in the channel 74.

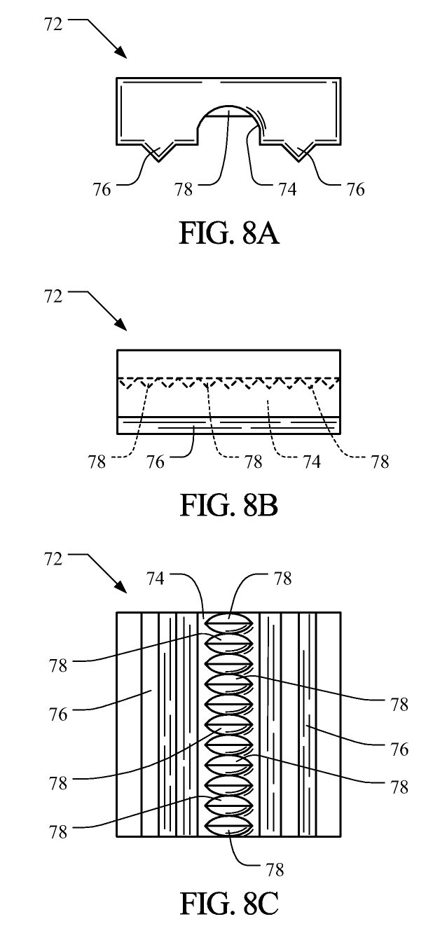

As seen in FIGS. 8A-8C, the cap 72 is illustrated as being a rectangular component. However, the cap 72 may adopt a variety of configurations as dictated by the design criteria of the construction into which it is incorporated. As seen in FIGS. 7 and 8A-8C, the cap further includes feet 76 on opposing sides of the channel 74 and which extend generally parallel to the channel 74. In that ultrasonic energy is concentrated at the interfaces of the two parts to be welded, the feet 76 operate as energy directors during ultrasonic welding of the cap 72 to the substrate 24.

As seen in FIG. 7, the feet 76 are generally triangularly shaped in cross-section, the apex of which is directed toward and in contact with the substrate 24. As noted above, during ultrasonic welding, energy is directed through the feet 76 causing welding of the feet 76 to the substrate 24. Additionally, the interfaces between the cap 72 and the wire 70 will result in the generation of heat within the channel 74 between the cap 72 and the wire 70. To further enhance the engagement of the wire 70 with the cap 72, the channel 74 of the cap 72 may be provided with a series of ribs 78. The ribs 78 extend transversely to the longitudinal direction of the channel 74 and operate as a mechanical engagement with the wire 70 as a result of the clamping force being exerted by the welding of the cap 72 to the substrate 24. As a result of the heating and compressing of the ribs, the ribs 78 melt and are depressed into and form a corrugated engagement with and along the wire 70, forming a strong bond between the cap 72 and the wire 70.

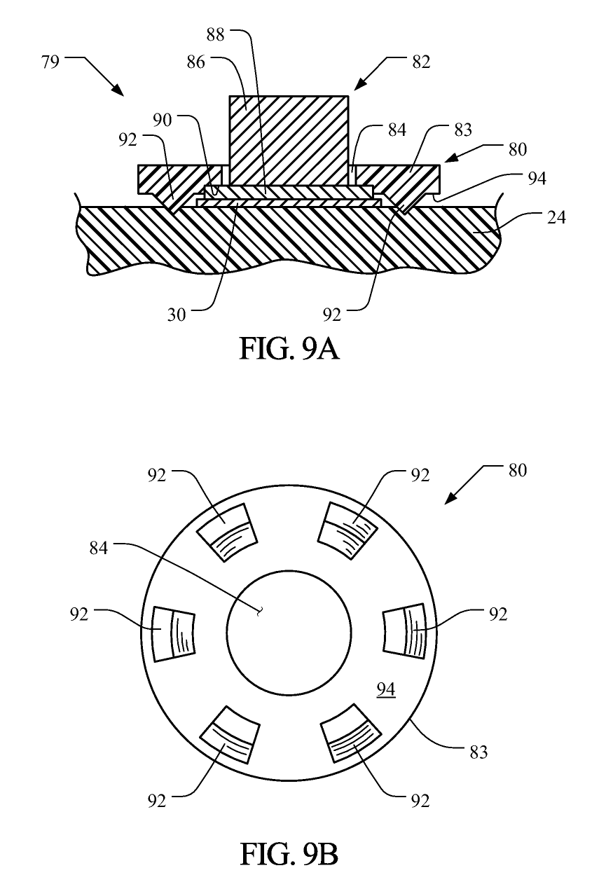

Referring now to FIG. 9, a further embodiment of the present invention is illustrated wherein an electrical connector 79 utilizes an annular cap 80 to retain a button 82 in engagement with the conductive mounting location 30, which is optionally shown as being directly provided on the substrate 24. The cap 80 includes an annular portion 83 defining a central annular opening 84. Through the annular opening 84 extends a post 86 from a base 88 of the button 82. The size of the annular opening 84 is such that the post 86 is able to extend through the opening 84. The base 88 has a size or diameter that is greater than that of the post 86 and the annular opening 84. Accordingly, the base 88 is prevented from passing through the opening 84. As a result, the base 88 abuts against a surface 90 around the perimeter of the annular opening 84. If desired, the surface 90 of the cap 80 may define an annular recess about the perimeter of the opening 84 so as to receive the base 88.

A series of feet 92 are circumferentially spaced around a lower surface 94 of the annular portion 83, as best seen in the bottom view of FIG. 9B. During ultrasonic welding of the connector of the present embodiment to the substrate 24, the feet 92 operate so as to direct the energy during the ultrasonic process to the areas of the feet. This results in the cap 80 being intermittently welded about the substrate 24 at the locations of the feet 92. During the ultrasonic welding process, the force applied to the cap and the button results in the base 88 of the button 82 being securely retained with the conductive contact location 30. If desired, solder may be employed between the base 88 of the button 82 and the conductive mounting location 30. When solder is employed, heat generated during the ultrasonic welding process will result in melting of the solder in further engagement of the button 82 with the conductive mounting location 30 on the substrate 24.

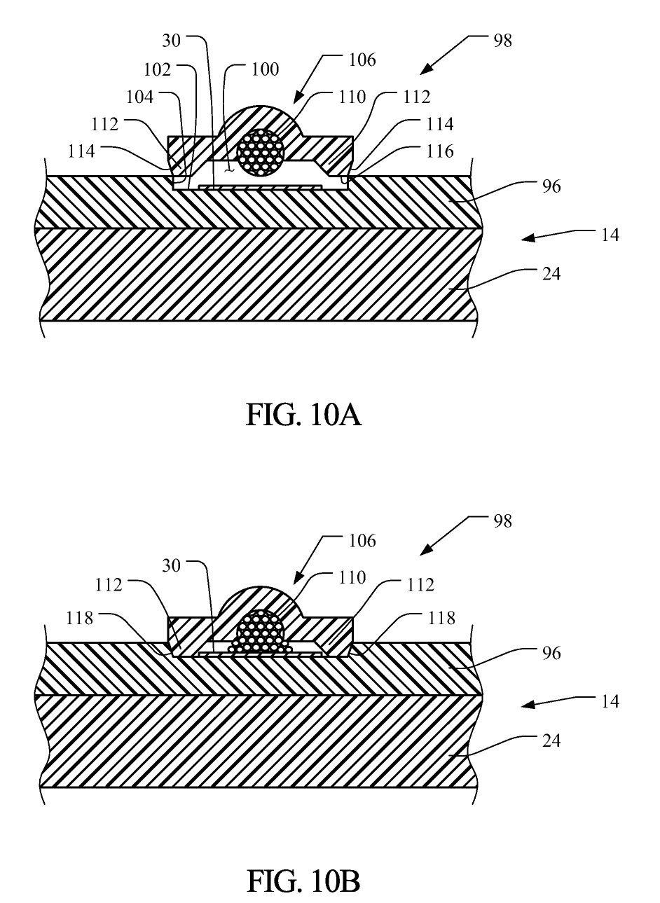

In all of the embodiments thus far described, the panel 14 included a substrate 24 and a conductive grid 12 with one or more optional protective coatings 29. Additionally, the panel 14 of each of the prior embodiments could be formed as what is known as a two-shot molded panel. In a two-shot molded panel, an additional portion of the panel 14 is injected as a second shot onto the previously formed substrate 24. Often, the second shot is injected about the perimeter of the substrate 24 and is of an opaque material so as to both rigidify the panel 14 and provide a blackout area about the border of the panel 14. As seen in FIGS. 10A and 10 B a second shot 96 of plastic material is provided on the substrate 24. The second shot 96 may similarly be utilized with the protective coating 29 provided on both the substrate 24 and the second shot 96. However, such a protective coating 29 is not illustrated in FIG. 10A or 10B.

The embodiment of FIGS. 10A and 10B additionally illustrates an ultrasonically welded shear joint construction for the attachment of an electrical connector 98 to the panel 14. As seen therein, a conductive mounting location 30 is provided within a recess 100 formed in the second shot 96 portion of the panel 14. As will be appreciated, the recess 100 could be formed in the substrate 24 of the panel 14. As illustrated, the recessed 100 includes a bottom surface 102 upon which the conducting mounting location 30 is applied and a pair of opposed side walls 104 that define the depth of the recess 100. Further as illustrated, the side walls 104 are generally perpendicular to the bottom surface 102.

The electrical connector 98 in FIGS. 10A and 10B includes a cap 106 having a central channel 108 extending longitudinally along the cap 106. The channel 108 receives a braided/twisted wire 110, which is appropriately sized for the channel 108. If desired, the end of the wire 110 received within the channel 108 may include solder therewith. Provided along opposing sides of the cap 106 are feet 112. The feet 112 extend from the cap in the same direction that the channel 108 faces. In a preferred embodiment, the feet 112 extend the longitudinal length of the cap 106. However, the feet 112 may be intermittently provided along the length of the cap 106.

In forming the feet 112, the lateral most surfaces of the feet define shear surfaces 114. The sheer surfaces 114 are generally angled with respect to the side walls 104 of the recess 100. The apex of the feet 112 is preferably a flat surface generally parallel to the bottom wall 102 of the recess 100. However, the apex of the feet 112 may include other shapes as well.

During ultrasonic welding of the electrical connector 98, pressure is applied to the cap 106 and ultrasonic energy transmitted thereto. The feet 112 operate to direct and focus the ultrasonic energy and as a result, the shear surfaces 114 and side walls 104 of the recess melt and become welded together, once the ultrasonic energy is abated. In addition, upon contact of the apex 116 of the feet 112 with the bottom surface 102 of the recess 100, the apex 116 of the feet 112 is also ultrasonically welded with the bottom surface 102. Similarly, the heat generated during ultrasonic welding effectuates soldering of the wire 110 to the conductive mounting location 30.

The preceding description of the preferred embodiment is merely exemplary in nature and is in no way intended to limit the invention or its application or uses. A person skilled in the art will recognize from the previous description that modifications and changes can be made to the preferred embodiment of the invention without departing from the scope of the invention as defined in the following claims.

What is claimed is:

1. A transparent plastic automotive panel system comprising:
a transparent plastic panel including a substrate;
an electrically conductive grid overlaying the substrate, the grid including at least one conductive mounting location; and
an electrical connector secured to the panel, the connector including a plastic portion and an electrically conductive portion, the plastic portion being ultrasonically welded to the panel and the conductive portion being electrically connected with the conductive mounting location.

2. The system of claim 1 further comprising a terminal of an electrical system, the terminal being electrically connected to the connector.

3. The system of claim 1 wherein the conductive grid is one of an antenna, an electroluminescent border, an electrical switch, a heating grid and a chromogenic device.

4. The system of claim 1 wherein the conductive grid is applied directly to the panel and the plastic portion of the connector extends through the conductive grid.

5. The system of claim 1 wherein the conductive grid is applied directly to the panel and the plastic portion of the connector extends at least partially around the conductive grid.

6. The system of claim 1 wherein the panel includes a protective coating over a substrate, the conductive grid being applied over the protective coating and the plastic portion of the connector extending through the conductive grid and the protective coating.

7. The system of claim 1 wherein the conductive grid is applied over a protective coating on a substrate of the panel and the plastic portion of the connector extends at least partially around the conductive grid.

8. The system of claim 1 wherein the conductive portion of the connector is insert molded within the plastic portion of the connector.

9. The system of claim 8 wherein the conductive portion includes a threaded bore.

10. The system of claim 1 wherein the connector includes a mounting pad having knurls formed thereon, the knurls being in contact with the panel.

11. The system of claim 1 wherein the connector includes a plastic cap, the cap being ultrasonically welded to the panel and retaining the conductive portion of the connector in contact with the conductive mounting location.

12. The system of claim 11 wherein the conductive portion of the connector is insert molded with the plastic cap.

13. The system of claim 11 wherein the conductive portion is a solder button located between the cap and the conductive mounting location.

14. The system of claim 11 wherein the cap includes a channel extending longitudinally along the cap, the conductive portion of the connector including a wire received within the channel.

15. The system of claim 14 wherein a plurality of transverse ribs is provided within the channel, the ribs engaging the wire

16. The system of claim 11 wherein the cap includes a plurality of feet, the feet being ultrasonically welded to the panel.

17. The system of claim 16 wherein the feet are intermittently spaced on the cap.

18. The system of claim 16 wherein the feet extend longitudinally along the cap.

19. The system of claim 16 wherein the feet are circumferentially located on the cap.

20. The system of claim 16 where the conductive mounting location has voids formed in locations corresponding with the feet locations on the cap.

21. The system of claim 11 wherein the conductive portion includes a post extending through a central opening in the cap.

22. The system of claim 21 wherein the post is connected to a base portion in contact with the conductive mounting location, the base portion being of a size larger than the central opening and being compressed between the cap and the conductive mounting location.

23. The system of claim 11 wherein the cap is engaged within a recess formed in the panel.

24. The system of claim 23 wherein the cap defines a shear joint with portions defining the recess in the panel.

25. The system of claim 23 wherein the cap includes a plurality of feet, the feet including side surfaces that are angled relative to side walls of portions defining the recess, the side surfaces of the feet being ultrasonically welded to the side walls of the panel and defining a shear joint therewith.

26. The system of claim 1 wherein the conductive grid is a heater grid integrally formed with the plastic panel, the heater grid having opposing busbars between which extend a plurality of grid lines, whereby the plurality of grid lines heat via resistive heating when an electrical current from a power supply travels through each of the plurality of grid lines.
